(19) United States
(12) Patent Application Publication
(10) Pub. No.: US 2022/0198382 A1
(43) Pub. Date: Jun. 23, 2022

(54) LOAD TRACKING WITH SUPPLY CHAIN MANAGEMENT SYSTEM AND PLATFORM

(71) Applicant: Target Brands, Inc., Minneapolis, MN (US)

(72) Inventors: Bryce Cooks, Minneapolis, MN (US); Michael Rorro, Minneapolis, MN (US); Anne Plaisted, Minneapolis, MN (US)

(21) Appl. No.: 17/126,699

(22) Filed: Dec. 18, 2020

(51) Int. Cl. G06Q 10/08

(52) U.S. Cl. CPC G06Q 10/0833; G06Q 10/087; G06Q 10/0838; G06Q 10/0832

(57) ABSTRACT

For each of a plurality of orders, an inventory readiness date is received that specifies a first calendar date on which the order of items should be ready at each items' respective destination location. For each item of each order, an arrival date before the readiness date is determined, the arrival date specifying a second calendar date on which the item should arrive at the item's respective destination location. For each item of the order, a corresponding load that the item is a member of is maintained. For each item of the plurality of orders, an inventory readiness metric is generated based on the item's travel based on tracking data for the item's load as the item's load travels from the item's respective source location to the respective destination location.

### TECHNICAL FIELD

This document generally relates to technology for supply chain management, including technology for tracking freight in transit through a supply chain.

### BACKGROUND

Supply chains are, in general, complex networks through which goods are supplied from producers to retailers and, ultimately, consumers. For example, supply chains can involve many different producers that are generating products for distribution, each of which may emanate from multiple different production and/or distribution facilities. These products can be transported using any of a variety of carriers, such as trucks, railcars, and/or boats, and in many instances may involve using multiple different carriers as items are transported through the supply chain (e.g., boat for transport over ocean, rail to transport from port to distribution center, and truck from distribution center to retail store). Additionally, items may be processed through one or more distribution center before they ultimately are delivered to retail stores and/or directly to consumers. As a result, supply chains can generate large numbers of data records, such as data identifying items and carriers that are transporting the items.

Supply chain tracking and management systems have included features to simply present the data records associated with the supply chain. For example, supply chain management systems have provided users with the ability to view a current data record for an item in the supply chain as well as an ability to view a historical log of data records for the item. With regard to loads—groups of goods that are being transported together within a common vessel (e.g., truck, train, boat)—supply chain systems traditionally been organized around dates of deliveries for loads to a destination, such as a distribution center, port, or other location.

### SUMMARY

The disclosed technology is generally directed to supply chain management systems and platforms to better and more accurately track and assess the state of the supply chain, including determining inventory readiness metrics which indicate whether loads are on schedule for delivery to distribution centers by a target date. The supply chain management systems and platforms build off of and use inventory ready dates (IRD) for items in the supply chain, which can be the date on which items will arrive at and be available for distribution at a distribution center (e.g., inventory unloaded from truck and available within distribution center for redistribution to, for instance, retail store or direct customer shipment). The IRD can be a singular target date that different actors and users of the supply chain can unify around, such as buyers, suppliers, distributors, carriers, and retailers. Previously, these different actors may have each had their own target dates and deadlines, which may have looked at only their smaller portion of the supply chain without broader supply chain considerations. IRD can be a unified target date against which all actors within the supply chain can organize and unify their activities around, with the ultimate goal being the holistic improvement and satisfaction of the supply chain's objectives—to supply requested items to distributors and retailers to meet demand for the items. IRD can take into account each leg of the supply chain, combining logistics, inventory management, and field operations to ensure that the IRD is accurate.

The disclosed supply chain management systems and platforms can use the IRD to track the status of the supply chain and to manage the allocation of resources, such as prioritizing shipments that have fallen behind their target IRD. The disclosed supply chain management systems and platforms can also provide visualization tools that can be used to visualize the supply chain and its contents, and to manage the supply chain.

To provide these features, which help to provide improve tracking, management, and assessment of the supply chain, including understanding changes over time to the state of the supply chain (as well as projected future states of the supply chain), the disclosed technology can use a load tracker which tracks the status of loads (e.g., trucks, trains) that are transporting goods to distribution centers. Unlike traditional techniques for tracking loads, which simply look at the progress of a load relative to a target date on which a carrier transporting the load will arrive at a distribution center (or other location), the disclosed technology assesses the status of a load based on the IRDs for the items comprising the load (e.g., pallets of goods contained in truck).

Each item that is part of a load can have a different IRD, so assessing the status of a load can involve assessing whether and to what extend the load will satisfy those different IRDs (e.g., proportion of items that are early, on time, or behind IRD) regardless of whether the carrier is on track for an expected delivery date for the load. For example, a truck (example carrier transporting load) can still have a target delivery date, but this target delivery date can be independent and separate from the IRD-based status of the load that the truck is carrying. For instance, even if the truck arrives according to a carrier delivery date (e.g., date on which carrier estimates/schedules delivery of load), it may be behind schedule according to an IRD-based load status assessment if a large proportion of the items (e.g., proportion based on quantity of items in load) will not meet their individual IRDs as of the delivery date. Conversely, even if the truck arrives at a distribution center late relative to its carrier delivery date, it may still be considered to be on-time according to an IRD-based load status assessment if a large proportion of the items still satisfy their corresponding IRDs as of the truck's actual arrival date.

A variety of techniques can be used to determine the IRD-based status of a load when its status is based on the combination of multiple different IRDs for items contained within the load. For example, various groups of IRD-based status can be generated, such as a “behind schedule” status, a “on time” status, and an “ahead of schedule” status. Items contained within a load can then be sorted into those groups based on their corresponding IRDs relative to the arrival of the load at the distribution center, and those groupings can be used to assess the status of the load. For instance, a proportion of items in each group can be used to assess the status of the load, such as by providing percentages of items within the load that fall into each group. Additional and/or alternative techniques for determining IRD-based status information for loads can be used, as described throughout this document.

In some implementations, a system is used for the management of data. The system includes one or more processors. The system includes computer-readable memory storing instructions that, when executed by the processors, cause the processors to perform operations comprising receiving, for each of a plurality of orders, an inventory readiness date that specifies a first calendar date on which the order of items should be ready at each items' respective destination location; determining, for each item of each order, an arrival date before the readiness date, the arrival date specifying a second calendar date on which the item should arrive at the item's respective destination location; maintaining, for each item of the order, a corresponding load that the item is a member of; generating, for each item of the plurality of orders, an inventory readiness metric based on the item's travel based on tracking data for the item's load as the item's load travels from the item's respective source location to the respective destination location; receiving a query that requests a load metric of a particular load to reflect the inventory readiness metrics of the items of the particular load; and returning, in response to the query, a load metric generated from an aggregation of the inventory readiness metrics of the items of the load. Implementations can include methods, devices, other systems, software, and computer-readable media, among other implementations.

Implementations can include some, all, or none of the following features. the operations further comprising generating a graphic user interface (GUI) having interaction elements to generate the query for the load metric; and displaying, in the GUI, the load metric. The query further requests location information for the load; and displaying, in the GUI, the load metric further comprises showing the location information for the load in a graphical image. The system of claim 2, wherein: the query further requests load metrics of a group of load matching a particular parameter; and displaying, in the GUI, the load metric further comprises displaying load metrics for each load matching the particular parameter. The system of claim 1, wherein the operations further comprise: receiving tacking data for a particular load; determining, based on the receive tracking data, that at least one inventory readiness metric should be updated based on the updated tracking data; and updating one or more readiness metrics of items of the load based on the received tracking data. Determining, based on the receive tracking data, that at least one inventory readiness metric should be updated based on the updated tracking data comprises: comparing the received tracking data to stored progress estimations for the load; determining that the load is failing to meet the progress estimations for the load based on the received tracking data. The progress estimations are generated based on carrier-provided estimates of progress for the load. The progress estimates are further generated based on historic accuracy scores for the carrier that record an accuracy measure of historic carrier-provided estimates from the same carrier for historic loads. A difference between the first calendar date and the second calendar date is determined based on capabilities of the destination location for the item.

The systems, devices, program products, and processes described throughout this document can, in some instances, provide one or more of the following advantages. For example, load tracking, as described throughout this document, can be used to better track and assess supply chain through the use of IRDs, and can provide for more accurate and holistic determinations, monitoring, and assessment the status of the supply chain. By tracking loads based on IRD, the status of loads within the context of the entire supply chain can be better assessed, which can provide greater insight into the status of the supply chain, as a whole. For example, determining whether a truck is on schedule to be delivered to distribution center at a scheduled time does not provide any insights into how this impacts the supply chain more broadly. Instead, it is the items that are contained within the truck and their expected delivery date at the distribution center that is at the core of the supply chain's status, which is not necessarily tethered to the truck's status. The disclosed technology can provide a better and more holistic view of the supply chain based on load status.

In another example, the disclosed technology can provide for improved of logistics data-management. For instance, complex orders made of hundreds, thousands, or millions of items can be tracked to create metrics that are far more simple than the raw tracking data, while still providing a viewer with enough information to understand the status of the order. This technology can be used for orders that will be supplied from many sources, to be sent to many destinations, by many different types of cargo haulers.

### DESCRIPTION OF DRAWINGS

FIG. 1 shows a diagram of a system for generating inventory readiness metrics.

FIG. 2 shows a flowchart of a process of generating inventory readiness metrics.

FIGS. 3 and 4 show schematic diagrams of an example readiness metric.

FIG. 5 shows a diagram of a system for generating inventory readiness metrics.

FIG. 6 shows a flowchart of a process for tracking inventory readiness metrics for a container of items.

FIG. 7 shows a flowchart of a process for responding to queries for inventory readiness metrics.

FIG. 8 shows a flowchart of a process for displaying inventory readiness metrics.

FIGS. 9-13 show graphic user interfaces for displaying inventory readiness information.

FIG. 14 is a schematic diagram that shows an example of a computing device and a mobile computing device.

Like reference symbols in the various drawings indicate like elements

### DETAILED DESCRIPTION

This document describes a technology platform for accurate tacking and assessing of the state of the supply chain, including whether loads and the orders they are on schedule for delivery to distribution centers. This technology uses an inventory ready date (IRD) as a key target for inventory shipped to destinations by the supply chain. From the IRD, various other milestone dates can be calculated. Then, orders consisting of hundreds, thousands, or millions of items are created to meet the IRD. From this, intermediate deadlines are created that, if met, make meeting the IRD likely. Metrics can be generated and displayed based on the items meeting or not meeting the deadlines created by this system.

IRDs can be tracked on a per-container basis. For example, a particular truck may have items for five different orders, and an IRD metric that shows the various IRD risks for the different items can be generated, updated, and displayed.

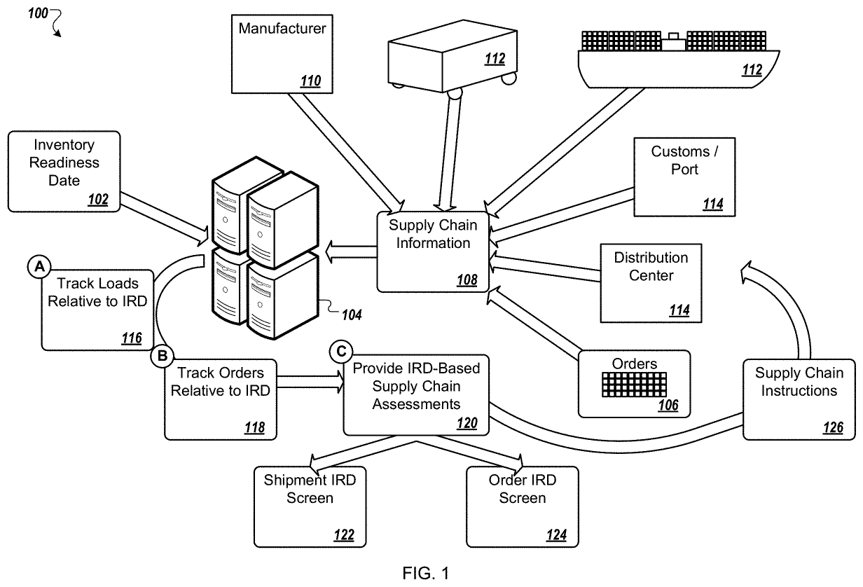

FIG. 1 shows a diagram of a system 100 for generating inventory readiness metrics. In general, an IRD 102 represents the date at which items ordered in a single order should be ready for use in a warehouse, distribution center, store, or other end location. This IRD 102 may be different, and later, than the day the items arrive at the distribution center. For example, if it takes 24 hours to unload a truck, unpack boxes, open containers, etc., before the item is sitting on the shelf ready to be accessed, the IRD 102 may be one day later than the day that the item should arrive in the truck at the distribution center.

A computer system 104 can receive information for one or more orders 106. The orders 106 may each specify a collection of information. For example, the orders 106 may specify a list of items, a destination for each item (e.g., various stores, distribution centers), a source for each item (e.g., a factory, manufacturer, or other source of the item), price information, and/or handling information (e.g., weight, size, compatible containers). Each order 106 may be matched to an inventory readiness date 102. In this way, a large, multi-facility enterprise may be able to create complex, multi-item, multi-facility orders in a unified process.

To monitor the status of the order (e.g., to help a user understand if the manufacturers and suppliers are shipping the ordered items), the computer system 104 can receive supply chain information 108 that contains information about the supply chain that is used to complete the orders 106. For example, the supply chain information 108 can include reporting data from manufacturers 110, including estimated and actual dates of manufacture, dates of shipment, etc. The supply chain information 108 can include reporting data for containers 112, including railcars, container trucks, ships, etc. The reporting data for containers 112 can include scheduling information, location tracking information, route information, etc. The supply chain information 108 can include reporting data from intermediate locations 114, including customs, ports, and distribution centers. In general, these intermediate locations can include locations where items, or containers holding the items, are temporarily held when in transit from their source (e.g., a manufacturer) to their destination (e.g., a fulfilment center). In some cases, the computer system 104 can filter, decorate, or otherwise alter the supply chain information 108 on receipt. For example, a large enterprise may generate a very large amount of data. Of this data, only a portion may be needed, and the unneeded portions may be filtered out. Similarly, the computer system 104 may decorate incoming supply chain information 108. For example, geolocation information may be decorated with the state or country in which the location resides.

The received information may be structured in the form of data events that each record a physical event that occurs in the supply chain. For example, a load arriving at a destination may create an event, a GPS location heartbeat message may be an event, etc. These events may be listened to by various components of the computer system 104 and, upon receipt of a new event, may launch one or more of the processes described in this document. In some cases, events may cause the update to data related to an order or load (e.g., updating location, IRD risk, or other data).

The computer system 104 can use the received information 102, and 108 to track loads 116 relative to the IRDs 102. For example, a load in a truck may contain items for five different orders 106. The computer system 104 may determine, for each of those five orders, if the truck's estimated arrival date will make that order's items on time, early, or late. The truck may have an estimated arrival date supplied by the trucking company, but this estimated arrival date may be different from the dates needed for IRDs 102 to be on time. For example, a delay up-stream of the shipping at the manufacturer 110 may make an IRD 102 in danger of being missed, even if the shipping by truck is done in an appropriate time. In such a way, a truck may be “on time” according to the trucking company, but the items in the truck may be “on time”, “early”, or “late” according to the IRDs 102. By separating the analysis of a carrier's performance with IRD risk, different and more useful information can be generated by the system. For example, a carrier that happens to receive loads late through no fault of their own (e.g., they service a port that has been experiencing bad weather, delaying unloading of boats) can be seen as performing well even if their loads have high IRD risk. Similarly, a carrier that often has unexpected delays but carries loads with low IRD risk may be seen as performing poorly.

The computer system 104 can track 118 orders relative to IRDs 102. For example, with the status of each item in a load relative to IRD 102 known, the computer system 104 can aggregate the IRD status of items in a single order across containers. This can include items from multiple sources being shipped to multiple destinations. In such a case, the breakdown of IRD status may not be a single number or value, but may instead be a multi-factor distribution of values. For example, 92% of items in an order may be on time, 5% may be early, and 3% may be late. This may be caused by most trucks carrying the items to different distribution centers carrying on-time items, two trucks carrying moving ahead of schedule, and one truck carrying items being delayed.

The computer system 104 can provide 120 IRD-based supply chain assessments. For example, the computer system 104 can generate one or more computer screens in the form of HTML web pages, application interfaces, or static reports that report the status of loads relative to IRD 122, orders relative to IRD 124, or in other formats. In addition, the computer system 104 can also use the IRD-based supply chain assessments to update and improve the operations of the supply chain. For example, one or more computer-readable instructions 126 can be generated in order to implement, modify, cancel, and/or otherwise perform various supply chain operations by supply chain actors, such as manufacturers 110, carriers transporting containers 112, distribution centers and ports 114, purchase ordering systems 106, retail stores, and/or other systems and actors that are part of a supply chain. For example, the supply chain assessment 120 can be used to generate supply chain instructions 126 to send to a carrier 112 and/or intermediate location (e.g., port 114, distribution center 114) to expedite a particular load that has many items with high IRD risk. These instructions may be automatically generated and configured to cause one or more systems (e.g., automated systems, a package handling system, truck dispatch system) to perform one or more actions that can reduce the overall IRD risk of the supply chain.

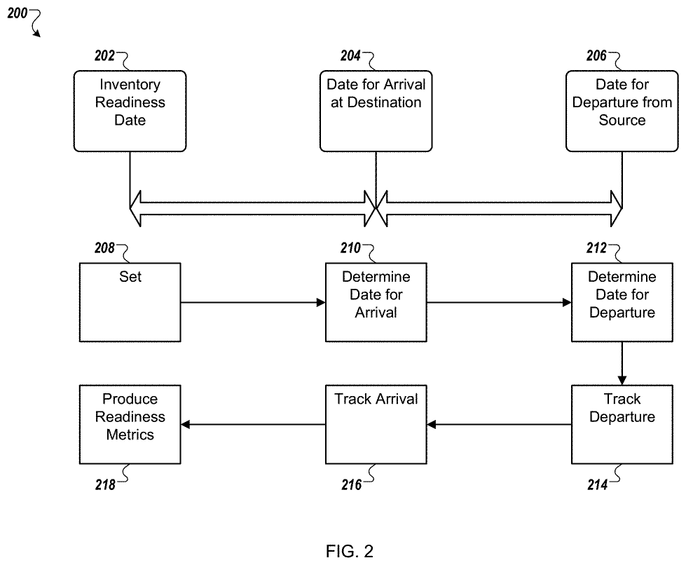

FIG. 2 shows a flowchart of a process 200 of generating inventory readiness metrics. In the process 200, an IRD 102 is set 208, and then from there intermediate dates are determined based on various factors of the supply chain. In general, these intermediate dates act as benchmarks to aid in the evaluation of IRDs 102—if the intermediate dates are being met, the order is likely on time, and if the intermediate dates are not being met, the order is likely to be late.

One intermediate date can be a date for arrival at destination 204, which may include a distribution center, a store, etc. As previously explained, the item may not be ready for use when it initially arrives at its destination. It may need to be unloaded, unpacked, inspected, assembled, and placed on a shelf, etc., before it is available for use. This process may take a significant enough amount of time that i) the process may impact the IRD if it goes slower than normal and ii) the process may be abstracted away without impacting the accuracy of the IRD analysis. For example, an item traveling down a two foot ramp from the back of a shelf to the front may take seconds and be fast enough to not need accounted for, but the unpacking discussed here may involve hours or days of work from arrival at the destination.

One intermediate date can be a date of departure from the item's source 206. This source may in some cases be the location where the item is manufactured, mined, generated, or assembled. In some cases, the source may be the first point at which the supply chain is automatically monitored. For example, a supplier of raw materials may not provide detailed, electronic tracking information until the raw materials arrive at the customs-controlled port where the material is being exported. In such a case, the customs-controlled port may be the source of the item, even if it is hundreds of miles from where the raw material is grown, extracted, manufactured, etc.

Two intermediate dates are shown here, but other intermediate dates can be used, including more or fewer dates. For example, if the items must from the source by rail car, then by ship, then by truck before arrival at the destination, additional intermediate dates may be used to represent the transition from rail to ship, and from ship to truck, as well as additional intermediate dates within each of those modes of transit (e.g., intermediate date for carrier reaching one or more intermediate locations and/or progress points). Additional and/or alternative intermediate dates can include stops in which some, but not all, of a load are unloaded or loaded. For example, a truck may have a load with items destined for two different retail stores, and each arrival and departure from the two retail stores may also have an intermediate date.

An IRD is set 208. For example, a computer system can receive, from outside of the computer system, input that specifies and IRD. This input may take the form of user input entering the data through a graphical user interface (GUI). This input may take the form of a data message transmitted over a data network. The receiving computer system can, using the input, store the IRD to computer memory to specify a first calendar date on which an order of items should be ready at each items' respective destination location. In some cases, the IRD is received as part of input that specifies the order for the computer system.

An arrival date is determined for each item of the order 210. For example, the computer system may access data for each item of the order and identify a destination for that item. For example, the order may specify one million identical items, with ten thousand items being ordered for each of one hundred distribution centers located across a country. Each distribution may have recorded the number of days that the center normally takes to unload and make ready such items—one day, two days, or three days. As such, the computer system may determine arrival dates 204 for each distribution center that are one day, two days, or three days before the IRD 202. As such, for each item of the order, an arrival date is set before the readiness date, the arrival date specifying a second calendar date on which the item should arrive at the item's respective destination location.

A departure date is determined for each item of the order 212. For example, the computer system may access data for each item of the order and identify a source for that item. For example, the items may be shipped from one of three factories spread across the country. Given the source of the item along with the destination now, the computer system can determine a length of time needed to transport the item from the source to the destination. Working backwards from the arrival date 204, the computer system can determine a departure date before the arrival date, the departure date specifying a third calendar date on which the item should depart the item's respective source location. For example, if a particular item has an IRD 202 of Friday, an arrival date 204 of Thursday, and requires two days to transit from the source to the destination, a departure date of Tuesday may be determined.

In some cases, determining, for each item of the order, an arrival date and determining, for each item of the order, a departure date, comprises querying a user for the second calendar date and the third calendar date. For example, the computer system may generate one or more GUIs to provide a user with an order specification screen. The user may input, into the screen, details about the order. This can include the IRD, the arrival date 204, and the departure date. In some implementations, this information may be generated based on secondary considerations input by the user. For example, the user may specify an IRD 202 and request arrival dates and departure dates calculated to reduce transit costs, time in transit, storage overhead, etc. In another example, the user may enter the departure date, as that may be inflexibly set by the manufacturer, and from there the GUI may guide the user to select other aspects of the order (e.g., shipping method or IRD), and the system may proposed values given those inputs (e.g., providing an IRD given the shipping method, providing a recommended shipping method given the IRD).

Events such as departure events are tracked 214 and arrival events are tracked 216. For example, as the items move through the supply chain, the computer system may receive tracking updates of such movement and identify transit events (e.g., departure events, arrival events). Based on these events, the computer system can keep up-to-date of location data for each item. In addition, estimates of future arrivals and/or departures can be updated based on the new information, and these projections can be compared against IRD to determine the risk level for various items (e.g., high risk of item missing IRD based on projected arrival date). For example, if a load arrives to one destination a day early, projected future arrivals and departures may be adjusted by one day to reflect this updated understanding of load status, which can additionally update the IRD-based status of the items contained with the load.

In some cases, this process can include receiving tracking data from a plurality of shipping containers, each shipping container containing at least one of the items. These shipping containers can include vehicles such as trucks, rail cars, and ships that may have global positioning data (GPS) or route data reported. These shipping containers can include boxes, bins, bags, or pallets that include bar codes, wireless data tags, or other technology used to generate tracking information. As the various types of shipping have different real-world capabilities and options (e.g., trucks can unload at a store, but boats are unlikely to) data for each type of container can be configured to reflect those real world capabilities and options. As such, data for different containers may be handled differently by the systems.

Readiness metrics are produced 218. For example, for each item of the order discussed in this example, the computer system can generate an inventory readiness metric based on the item's travel based on tracking data for the item as the item travels from the item's respective source location to the respective destination location. For example, the computer system can compare actual departure events and actual arrival events to the planned arrival date 204 and the planned departure date 206.

In one example, items that actually depart or arrive before their planned dates can be tagged as “ahead of schedule”, items that actually depart or arrive on their planned dates can be tagged as “on schedule”, and items that actually depart or arrive after their planned dates can be tagged as “behind schedule.” In another example, the metric can report a risk of being behind schedule. Items with actual dates ahead of or on the planned dates can be tagged as low risk, items with actual dates behind the planned dates may be marked as “low risk” of missing their IRD, representing the supply chain's flexibility to expedite some items when needed, and items with actual dates more than a day after their planned dates can be marked as “high risk” of missing their IRD.

As tracking events are received, the computer system can continually update the IRD metrics. For example, a particular item may have an actual departure date matching the planned departure date 206. The rail car carrying the item may be delayed in transit, taking four days to travel instead of the planned two, resulting in an actual arrival date that is two days after the planned arrival date 204. In such a case, the item may initially be given an “on time”, “green” or otherwise favorable IRD metric. However, when the arrival date lapses (or when another intermediate date lapses), the computer system can update the readiness metric for that item to “late”, “red”, or otherwise unfavorable.

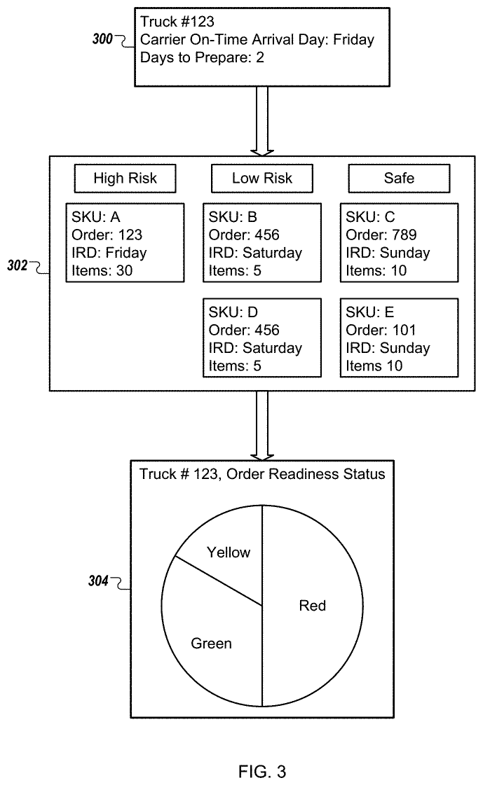

FIG. 3 shows a schematic diagram of an example readiness metric. In this example, the metric can report a risk of being behind schedule. Items with actual dates ahead of or on the planned dates can be tagged as a “safe” risk level, items with actual dates behind the planned dates may be marked as “low risk” of missing their IRD, representing the supply chain's flexibility to expedite some items when needed, and items with actual dates more than a day after their planned dates can be marked as “high risk” of missing their IRD.

Data 300 can be stored by a computer system to record data related to a container that is used to ship items for an order. For example, items for the order may be recorded as in transit on truck #123. The carrier may have a carrier-scheduled on-time arrival date of Friday. However, as explained above, this date may be different from the IRD or other intermediate dates used to determine IRD metrics. In addition, the data 300 can record the number of days needed to unpack and make ready the items once they reach their destination.

Data 302 can be stored by the computer system to maintain the IRD status of items in the truck #123. In this example, the truck is carrying a total of 60 items across five Stock Keeping Units (SKUs). These 60 items are each assigned to one of four orders, but have been shipped in the truck #123 to enhance overall efficiency of the supply chain. Because they are part of different orders, they may have assigned different IRDs. As such, items from the same truck—a truck that the carrier identifies as “on time”—can nevertheless have different IRD metrics. In this case, items with an IRD of Friday are more than a day behind schedule and marked as “high risk”, items a day behind schedule are marked as “at risk”, while items on schedule are marked as “safe”.

Report 304 reports the risk status of the items in the truck in the form of a multi-factor metric that represents the inventory readiness metric of each item contained by the container. Of note, the pie chart of the report 304 reports risk weighted by item count, not by SKU. So while there are five SKUs in the truck, one SKU contains half of the items and those items are at risk. As such, the pie chart shows half of the area marked “red” for “high risk”. Similarly, “low risk” and “safe” have the same number of SKUs but different numbers of items, and thus the “yellow” and “green” areas are of unequal size.

The report 304 may be displayed to a user on a screen, by being printed on paper, etc. With this information, the user can quickly identify the status of the items in the truck and determine if any remedial action should be taken. For example, as this report contains large amounts of red followed by yellow, the user may identify it as a high-priority for redial action. As such, the user may generate an order for the supply chain to expedite the truck #123.

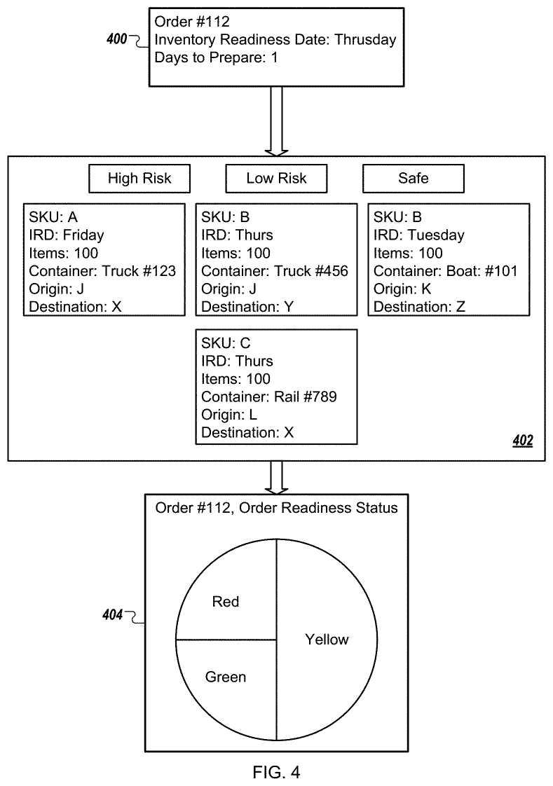

FIG. 4 shows a schematic diagram of an example readiness metric. In this example, the metric can report a risk of being behind schedule. Items with actual dates ahead of or on the planned dates can be tagged as a “safe” risk level, items with actual dates behind the planned dates may be marked as “low risk” of missing their IRD, representing the supply chain's flexibility to expedite some items when needed, and items with actual dates more than a day after their planned dates can be marked as “high risk” of missing their IRD.

Data 400 can be stored by a computer system to record data related to items for an order across many containers. For example, items for the order #112 may be recorded with associated metadata. For example, the data 400 can record the IRD for an order and number of days needed to unpack and make ready the items once they reach their destination.

Data 402 can be stored by the computer system to maintain the IRD status of items in the order #112. In this example, 400 items are being transported from various sources, to various destinations, as grouped together by three different SKUs of items (A, B, and C) being transported from three different origin locations (J, K, and L) to three different destinations (X, Y, and Z across four different containers, truck #123, truck #456, rail car #789, and boat #101. As depicted by the combinations of SKU, source location, destination location, and containers that are part of order #112, an order can include multiple different items (e.g., SKUs A, B, and C) that are fulfilled from multiple different source locations (e.g., origins J, K, and L) to multiple different destination locations (e.g., destinations X, Y, and Z) using multiple different carriers (e.g., truck #123, truck #456, rail car #789, and boat #101). Due to this complexity, simply tracking the progress of each of portion of an order is a challenge, let alone the added difficulty in assessing the overall and current IRD-based risk of the order (and its component parts) being unavailable across all of these different moving parts (e.g., different SKUs, source locations, destinations, containers). For example, because each items that is part of the order (represented by SKUs) may be at different points in its transit path, they may have assigned different statuses. As items transition along their transit path, which may include being transferred between different containers, the status of the items and their projection relative to IRD can be updated (e.g., events identifying progress of items can be received and used to update IRD-based status for items). As such, items set to arrive at least a day before the IRD are set to “safe”, items set to arrive on the IRD date are marked “low risk”, and items arriving after the IRD date are marked as “high risk”. Other rating schemes may be used.

Report 404 reports the risk status of items in the order in the form of a first multi-factor metric that represents the inventory readiness metric of each item of the order. Of note, the pie chart of the report 404 reports risk weighted by item count, not by container. However, in this case, each container contains the same number of items, so the size of each section of the chart happens to correlate to the number of containers in each risk category.

The report 404 may be displayed to a user on a screen, by being printed on paper, etc. With this information, the user can quickly identify the status of the items in the order and determine if any remedial action should be taken. For example, as this report contains large amounts of red followed by yellow, the user may identify it as a high-priority for redial action. As such, the user may generate an order for the supply chain to temporarily halt activities that use many of the items in the order #112.

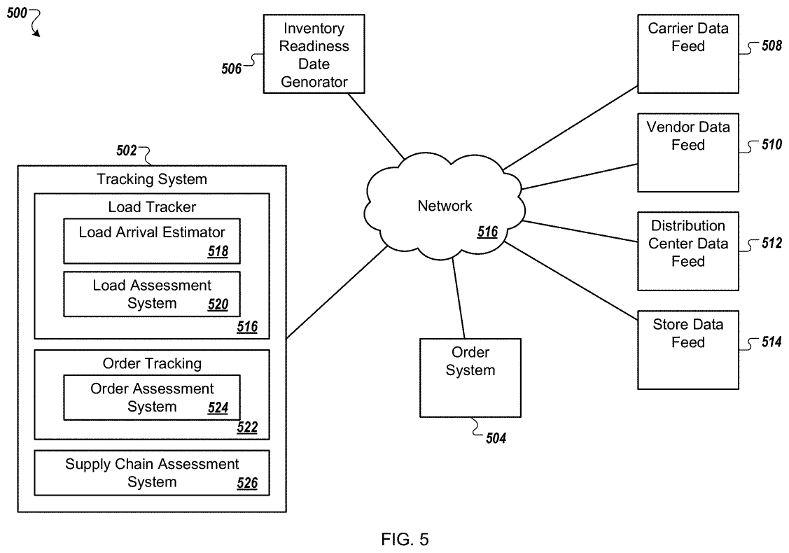

FIG. 5 shows a diagram of a system 500 that includes computer devices that operate to generate inventory readiness metrics. In the system 500, a tracking system 502 can receive data from other elements of the system 500 and can generate new data to report on the status of the supply chain. For example, an order system 504 can report, to the tracking system 502, details about orders that are to be fulfilled using the supply chain. This order information can include a listing of items in the order, sources for the items, destinations for the items, etc. An inventory readiness date generator 506 can generate, from the order information and other data in the system 500, inventory readiness dates for the orders.

Various data feeds can supply data to the tracking system 502 on an ongoing basis. A carrier data feed 508 can supply the tracking system 502 with carrier tracking data. This data can include shipping events (e.g., departure from a particular location by a particular container), status data (e.g., geolocation data, speed, direction, fuel status), and carrier-based-status values (e.g., on time, ahead of schedule, or late, according to carrier quality of service agreements).

A vendor data feed 510 can supply the tracking system 502 with vendor tracking data. This data can include vendor events (e.g., sale of items that are ordered), status data (e.g., where items are in the manufacturing process), and vendor-based-status values (e.g., if the manufacturing process is on time, ahead of schedule, or late, according to vendor contracts). A distribution center data feed 512 can supply the tracking system 502 with distribution center tracking data. This data can include information about the status of items in the distribution center (e.g., including both items that were ordered as part of the orders discussed above and items not ordered as discussed), and the capabilities of the distribution center (e.g., time to unload items, ability to sort and assemble parts). A store data feed 514 can supply the tracking system 502 with store tracking data. This data can include information about the status of items arriving and for sale at stores, and the capabilities of the stores (e.g., time to unload items, ability to sort and assemble parts).

A network 514 can provide data communication between elements of the system 500. For example, the data network can create, maintain, and tear down data connections that allow messages to be sent by one element and received by another element. The network 514 can include the Internet, private networks, public networks, etc.

The tracking system 502 can include a load tracker 516 that is able to execute operations to track loads of items. For example, the load tracker 516 may maintain, in computer memory, a list of loads in containers. This list of containers can also include, for each container, a list of items in the load, the order number of the items, the locations of the containers, etc. A load arrival estimator 518 can execute operations to estimate arrival times of loads. For example, the load estimator 518 may maintain, in computer memory, a list of planned arrival dates (e.g., arrival dates 204) for each load being tracked. The load estimator 518 may also store other data to determine if the loads being tracked are likely to meet their planned arrival dates. For example, this data may include intermediate benchmarks, geolocation data, travel velocity, traffic data, weather data, etc. This other data may be submitted to a classifier to identify one or more likely arrival dates.

A load assessment system 520 may submit this other data (e.g., the intermediate benchmarks, geolocation data, travel velocity, traffic data, weather data, etc.) to one or more classifier functions that return one or more estimated arrival dates, given the input. This estimated date may take the form of a single date estimated to be the most likely, a plurality of dates each having an associated confidence value, etc.

The tracking system 502 can include an order tracking system 522 that is able to execute operations to track orders of items. For example, the order tracker may maintain, in computer memory, a list of orders of items. This list of orders can also include, for each order, a list of containers containing items of the order, SKUs of the items, etc. A order assessment system 524 may submit data received from the load tracker 516 (e.g., estimated arrival times) to one or more classifier functions that return one or more order risk scores that report the risk each item of the order has of missing its assigned IRD.

A supply chain assessment system 526 of the tracking system 502 can generate assessments of the supply chain. For example, the system 526 can generate the screens 112 and 124, the report 304, and or the report 404.

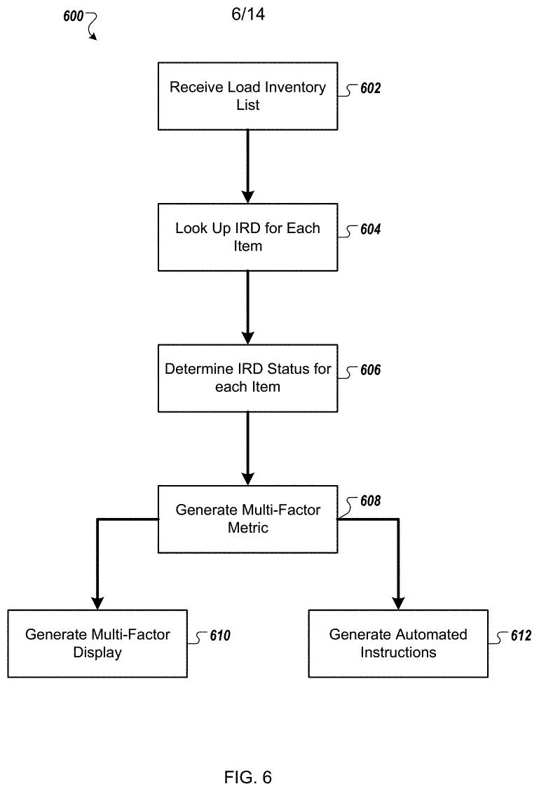

FIG. 6 shows a flowchart of a process 600 for tracking inventory readiness metrics for a container of items. For example, the process 600 can be performed by the tracking system 502. Therefore, the process 600 will be described with reference to the system 500. The process 600 may be performed, for example, after a new order has been received and IRDs have been set for the items contained within the order.

A load inventory list is received 602. For example, the load tracking system 502 can receive, from the vendor data feed 510, a file listing all items that are packaged into a single pallet on a truck. Additionally or alternatively, the load tracking system 502 can receive, from the carrier data feed 508, a file listing all items that are on a truck. The load tracker 518 can update, in computer memory, data related to each of these items to specify that the item is associated with the truck.

IRDs for each item of the inventory list are looked up 604. The load assessment system 520 can listen for updates in the computer memory. When the new load information is created in 602, the load assessment system 520 can access IRD dates for each item from the IRD generator 506, as well as other data such as intermediate dates, etc.

An IRD status for each item is determined 606. The load assessment system 520 can compare the status of each item in the load against the next upcoming date (e.g., intermediate date, delivery date) to determine the length of time (e.g., in days, hours, minutes, and/or seconds) available to meet the next upcoming date. The load assessment system 520 may supply this information to a classifier that takes, for example, the length of time and other related data to produce an IRD status. The status may take the form of a risk value, a risk classification, an expected delay value, etc.

A multi-factor metric for the load is generated 608. For example, the multi-factor metric may record, for each item in the load, the items IRD status. This recording may aggregate the statuses (e.g., a count of each status value, a summation of delay values) or may keep the statuses individual.

A multi-factor display is generated 610. For example, one or more GUI screens or static reports may be generated to display the multi-factor metric of IRD for the single load. This may take the form of a pie chart, bar chart, overall risk value, etc.

Automated instructions are generated 612. For example, computer instructions can be assembled from template instructions to alter the function of the supply chain. These instructions may be transmitted by data network to one or more automated systems that can operate on the instructions. These instructions may be structured in a way that improves the IRD risk of one or more items, or of the supply chain in total. For example, a load may be expedited to hop to the front of an unloading queue at a dock or loading bay.

The process 600 may be used in a variety of supply-chain contexts. In some cases, the process 600 may be particularly useful in situations where the supply chain includes a number of low-volume vendors, when compared to the transport capacity of a single vehicle. For example, a single truck may be used to pick up items from vendors of stationary, gift cards, and other paper-goods. As will be understood, these items may be quite small in comparison with the capacity of a truck, and thus a single truck may be used to pick up items from each of these vendors in a single route, even as the different items are each part of different purchase orders. That one truck may then then bring the items to a deconsolidator for deconsolidation, sorting, and then loading to trucks destined for different distribution centers. In such a case, the IRDs of the incoming truck may be an important input to the operation of the deconsolidator, to aid in efficient sorting and prioritization of trucks. As will be understood, a similar patent may apply, for example, with container ships hauling very large containers of goods through international channels.

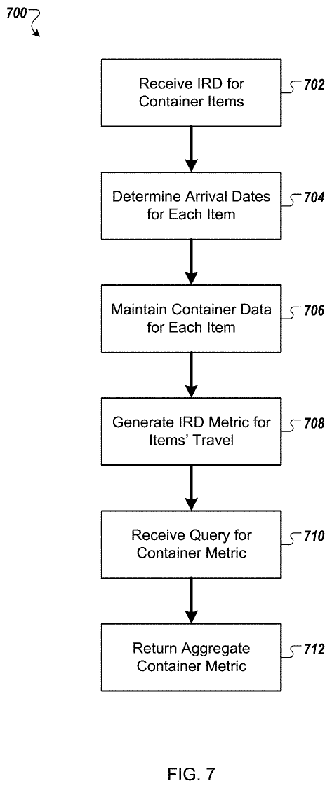

FIG. 7 shows a flowchart of a process 700 for responding to queries for inventory readiness metrics. For example, the process 700 can be performed by the tracking system 502. Therefore, the process 700 will be described with reference to the system 500.

For each of a plurality of orders, an inventory readiness date is received 702 that specifies a first calendar date on which the order of items should be ready at each items' respective destination location. For example, the load tracking system 502 can receive, from the order system 504 a list of orders. Then, the load tracking system 502 can receive, from the inventory readiness date generator 506, IRDs for each order. In some cases, IRDs may be received first or contemporaneously. This can be useful, for example, in the monitoring of where containers are in a supply chain, and what risk is caused.

For each item of each order, arrival dates before the readiness date are determined 704. For example, the load tracker 518 can identify various loads that contain one or more items of the load. The load arrival estimator 518 may determine various arrival dates that must be met for each item at various locations in the supply chain so that the items are ready by the IRD of the order of the item. This arrival date specifies a second calendar date on which the item should arrive at the item's respective destination location.

For each item of the order, a corresponding load that the item is a member of is maintained 706. For example, the load tracker 518 may store, in computer memory, a record for each item. The items' records may have a field identifying the load to which the item is a member.

For each item of the plurality of orders, an inventory readiness metric is generated 708 based on the item's travel based on tracking data for the item's load as the item's load travels from the item's respective source location to the respective destination location. For example, the load assessment system 520 can compare the status of the load to one or more benchmarks or other data to determine if the load in on schedule, deviating from schedule, etc. Based on this comparison, an estimated arrival date of the load may be determined, and based on the estimated arrival date of the load compared to the arrival dates calculated, an inventory readiness metric for each item can be generated.

A query is received 710 that requests a load metric of a particular load to reflect the inventory readiness metrics of the items of the particular load. For example, an element of the system 500 or another element in communication with the tracking system 502 (e.g. a web-based client) can submit a query to the tracking system for an inventory readiness metrics for a particular load. This load may be uniquely identified by a unique identifier, identified by way of a match to a query parameter (e.g., a truck within a particular geographic location, all in-transit ships departing from a given source).

In response to the query, a load metric generated from an aggregation of the inventory readiness metrics of the items of the load is returned 712. To responds to the we query, a multi-factory metric may be generated. For example, the multi-factor metric may record, for each item in the load, the items IRD status. This recording may aggregate the statuses (e.g., a count of each status value, a summation of delay values) or may keep the statuses individual.

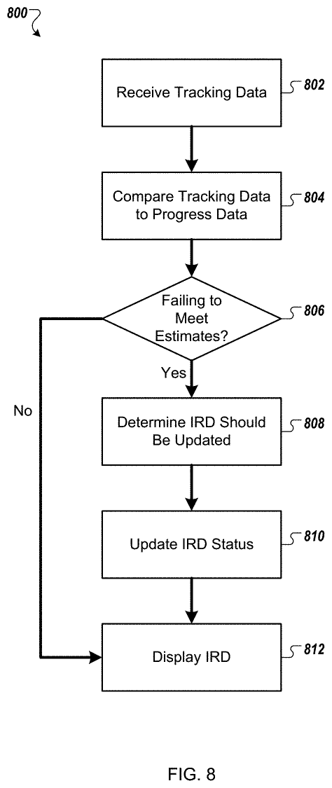

FIG. 8 shows a flowchart of a process for displaying inventory readiness metrics. For example, the process 800 can be performed by the tracking system 502. Therefore, the process 800 will be described with reference to the system 500.

Tacking data for a particular load is received 802. For example, the load tracker 516 can receive periodic data updates about load status from sources such as the carrier data feed 508. This information can include geolocation, times of the location recordings, etc. With this information, the load tracker 516 can maintain in the computer memory an updating status for each load.

The received tracking data is compared to stored progress estimations for the load 804. For example, the load assessment system 520 can compare a load's status recorded in the computer memory with a progress estimation for the load. This progress estimation may include one or more milestones that estimate a time when the load should pass a particular location, or may contain a travel speed the load is estimated to maintain, etc.

In some cases, the progress estimations are generated based on carrier-provided estimates of progress for the load. For example, the carrier data feed 508 may provide a carrier-provided estimate of the date or time that a load should arrive at a milestone location. In some cases, this carrier-provided estimate may be used directly as the stored progress estimation discussed above. However, in some cases, the carrier-provided estimates may be ignored or modified. For example, the progress estimates may be based on historic accuracy scores for the carrier that record an accuracy measure of historic carrier-provided estimates from the same carrier for historic loads. That is to say, a consistently inaccurate carrier may not be given much weight in the determination of the stored progress estimation discussed above—a consistently optimistic carrier's estimates may be changed to add a day or two of transit, for example.

If it is determined that the load is failing to meet the progress estimations for the load based on the received tracking data 806, the at least one inventory readiness metric should be updated 808 based on the updated tracking data. In response, one or more readiness metrics of items of the load based on the received tracking data 810. For example, if a load is supposed to pass a particular milestone on Friday, and the current status is that it has not passed milestone on the end of the day Friday, the process 800 may be used overnight Friday night and may result in an on-time item in the load being changed to at-risk of missing the IRD for the order of the item.

If it determined that the load is determined not to be failing to meet the progress estimations for the load, or after the inventory readiness metrics have been updated, the inventory readiness metrics are displayed 812. For example, after being update or not updated, the IRD may be displayed to the user in one or more GUIs, some of which are discussed below. As will be understood, the IRD itself may be held constant through the lifetime of a load, with the IRD status changing depending, for example, if it is ahead of or behind schedule.

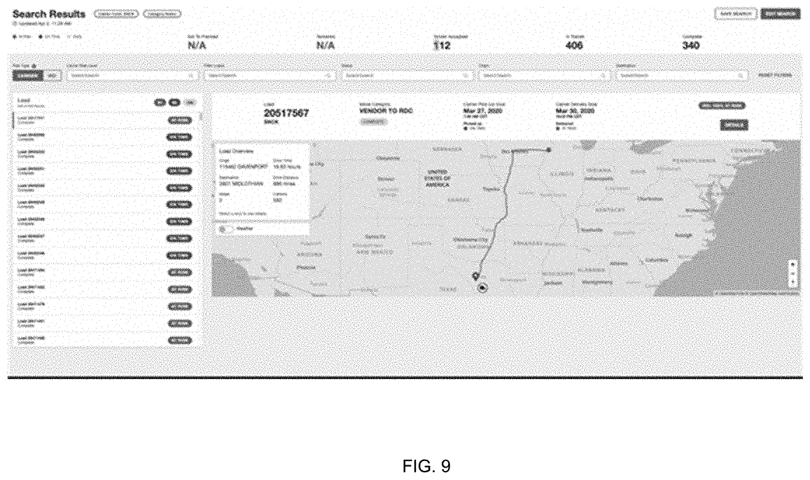

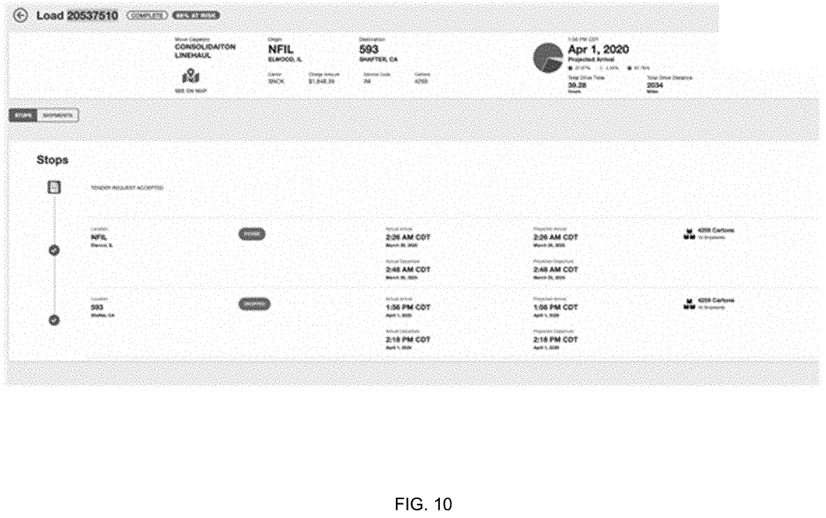

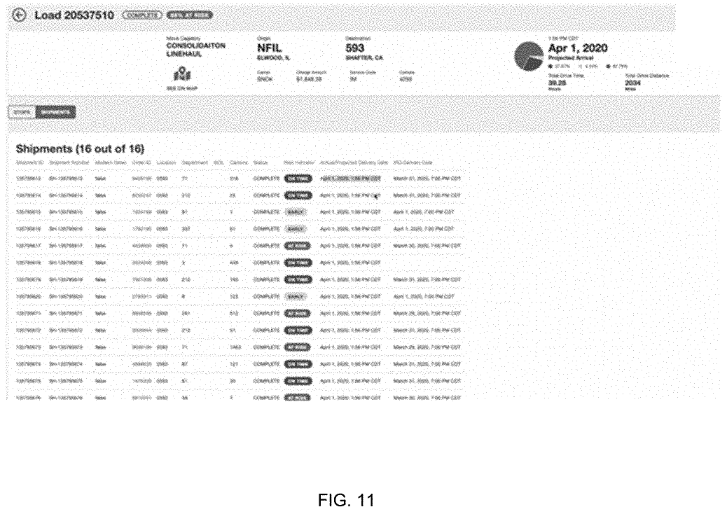

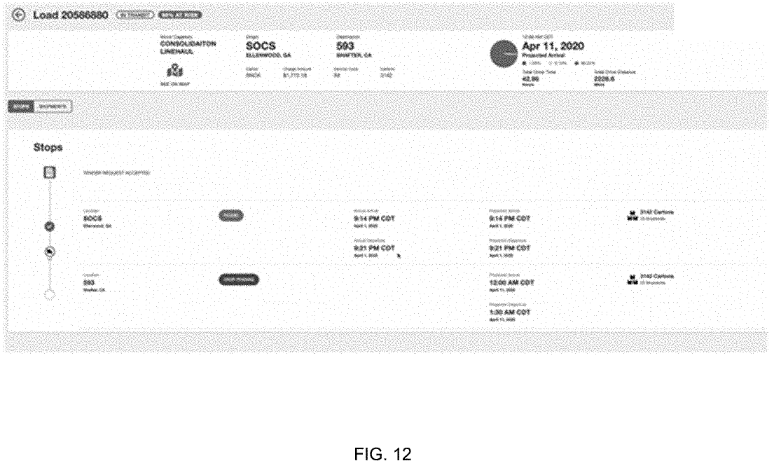

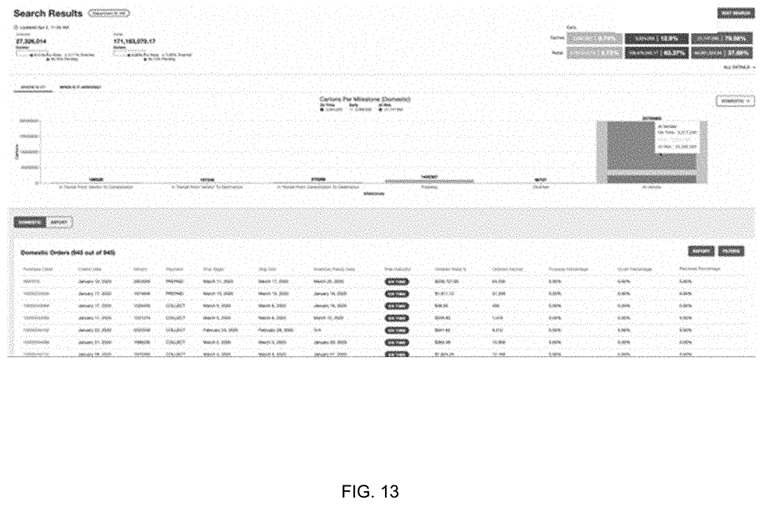

FIGS. 9-16 show GUIs 900-1300 for displaying inventory readiness information. For example, the GUIs 900-1600 may be displayed as part of displaying 812 inventory readiness metrics or in other processes. Each of the GUIs 900-1300 can have interactive elements to allow a user to generate queries, e.g., to the system 500, to query load metrics and other IRD metrics. Responses to these queries (load metrics, IRD metrics, etc.) can then be displayed in the GUIs.

GUI 900 shows interactive elements that can be used to display a load's location on a map. For example, the GUI can be used to generate queries that request location information for the load and that display the location information for the load in a graphical image (e.g., a map) along with the load metric of IRD.

GUI 1000 shows interactive elements that can be used to display milestone for a load. For example, the GUI can be used to show stops along the loads path, and dates/times that the load should arrive and/or depart from those stops. As the load travels, the location relative to the stops may be updated.

GUI 1100 shows interactive elements that can be used to display IRDs of various items in a single load. For example, the GUI may show a list of all items within a load along with a graphical indication (text, glyphs, color, image, animations, etc.) that represent IRD status of the items. As the items may be associated with different orders, the different items may have different IRD status. By showing theses statuses graphically, a user can see a holistic representation of IRD risk for a single load.

An element such as a button can be manipulated by user input to expand or collapse list of items in a load, containers in a load, the ordering of items or containers, etc. For example, this may be used to aid in planning for loading and unloading the load.

An element such as a button can be manipulated to sort and filter a shipment. For example, a shipment can be ordered/filtered based on purchase order number, freight configuration, load sequence, etc.

GUI 1200 shows interactive elements that can be used to display estimated arrival dates of loads. For example, as a load's estimated arrival date deviates from planned arrival dates, this deviation can be shown, along with the deviations impact on IRD.

GUI 1300 shows interactive elements that can be used to display search results to a request for IRDs for a single order. For example, the GUI can be used to generate queries that request a group of loads matching a particular parameter and that display the load metrics for each load matching the particular parameter. In some cases, the group of loads may only be a single load. For example, the user may search for a particular load by a unique identifier, or may search on a parameter that only one load matches. In other cases, the results may be for multiple loads. For example, the user may search for all loads from a particular carrier, loads of a particular status, by vehicle type, etc.

An element such as a button can be manipulated to collect related data for display. For example, load projections and purchase-order level information may be displayed to the user at the user's request.

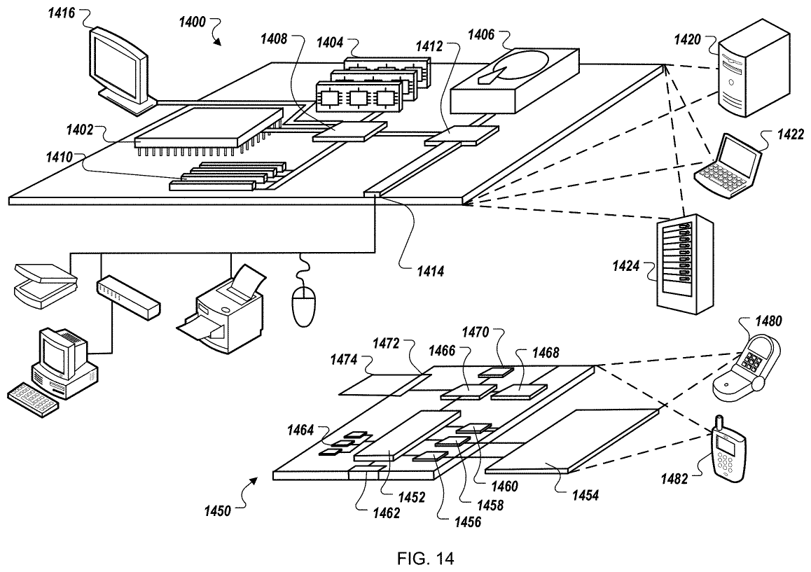

FIG. 14 shows an example of a computing device 1400 and an example of a mobile computing device that can be used to implement the techniques described here. The computing device 1400 is intended to represent various forms of digital computers, such as laptops, desktops, workstations, personal digital assistants, servers, blade servers, mainframes, and other appropriate computers. The mobile computing device is intended to represent various forms of mobile devices, such as personal digital assistants, cellular telephones, smart-phones, and other similar computing devices. The components shown here, their connections and relationships, and their functions, are meant to be exemplary only, and are not meant to limit implementations of the inventions described and/or claimed in this document.

The computing device 1400 includes a processor 1402, a memory 1404, a storage device 1406, a high-speed interface 1408 connecting to the memory 1404 and multiple high-speed expansion ports 1410, and a low-speed interface 1412 connecting to a low-speed expansion port 1414 and the storage device 1406. Each of the processor 1402, the memory 1404, the storage device 1406, the high-speed interface 1408, the high-speed expansion ports 1410, and the low-speed interface 1412, are interconnected using various busses, and can be mounted on a common motherboard or in other manners as appropriate. The processor 1402 can process instructions for execution within the computing device 1400, including instructions stored in the memory 1404 or on the storage device 1406 to display graphical information for a GUI on an external input/output device, such as a display 1416 coupled to the high-speed interface 1408. In other implementations, multiple processors and/or multiple buses can be used, as appropriate, along with multiple memories and types of memory. Also, multiple computing devices can be connected, with each device providing portions of the necessary operations (e.g., as a server bank, a group of blade servers, or a multi-processor system).

The memory 1404 stores information within the computing device 1400. In some implementations, the memory 1404 is a volatile memory unit or units. In some implementations, the memory 1404 is a non-volatile memory unit or units. The memory 1404 can also be another form of computer-readable medium, such as a magnetic or optical disk.

The storage device 1406 is capable of providing mass storage for the computing device 1400. In some implementations, the storage device 1406 can be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product can also contain instructions that, when executed, perform one or more methods, such as those described above. The computer program product can also be tangibly embodied in a computer- or machine-readable medium, such as the memory 1404, the storage device 1406, or memory on the processor 1402.

The high-speed interface 1408 manages bandwidth-intensive operations for the computing device 1400, while the low-speed interface 1412 manages lower bandwidth-intensive operations. Such allocation of functions is exemplary only. In some implementations, the high-speed interface 1408 is coupled to the memory 1404, the display 1416 (e.g., through a graphics processor or accelerator), and to the high-speed expansion ports 1410, which can accept various expansion cards (not shown). In the implementation, the low-speed interface 1412 is coupled to the storage device 1406 and the low-speed expansion port 1414. The low-speed expansion port 1414, which can include various communication ports (e.g., USB, Bluetooth, Ethernet, wireless Ethernet) can be coupled to one or more input/output devices, such as a keyboard, a pointing device, a scanner, or a networking device such as a switch or router, e.g., through a network adapter.

The computing device 1400 can be implemented in a number of different forms, as shown in the figure. For example, it can be implemented as a standard server 1420, or multiple times in a group of such servers. In addition, it can be implemented in a personal computer such as a laptop computer 1422. It can also be implemented as part of a rack server system 1424. Alternatively, components from the computing device 1400 can be combined with other components in a mobile device (not shown), such as a mobile computing device 1450. Each of such devices can contain one or more of the computing device 1400 and the mobile computing device 1450, and an entire system can be made up of multiple computing devices communicating with each other.

The mobile computing device 1450 includes a processor 1452, a memory 1464, an input/output device such as a display 1454, a communication interface 1466, and a transceiver 1468, among other components. The mobile computing device 1450 can also be provided with a storage device, such as a micro-drive or other device, to provide additional storage. Each of the processor 1452, the memory 1464, the display 1454, the communication interface 1466, and the transceiver 1468, are interconnected using various buses, and several of the components can be mounted on a common motherboard or in other manners as appropriate.

The processor 1452 can execute instructions within the mobile computing device 1450, including instructions stored in the memory 1464. The processor 1452 can be implemented as a chipset of chips that include separate and multiple analog and digital processors. The processor 1452 can provide, for example, for coordination of the other components of the mobile computing device 1450, such as control of user interfaces, applications run by the mobile computing device 1450, and wireless communication by the mobile computing device 1450.

The processor 1452 can communicate with a user through a control interface 1458 and a display interface 1456 coupled to the display 1454. The display 1454 can be, for example, a TFT (Thin-Film-Transistor Liquid Crystal Display) display or an OLED (Organic Light Emitting Diode) display, or other appropriate display technology. The display interface 1456 can comprise appropriate circuitry for driving the display 1454 to present graphical and other information to a user. The control interface 1458 can receive commands from a user and convert them for submission to the processor 1452. In addition, an external interface 1462 can provide communication with the processor 1452, so as to enable near area communication of the mobile computing device 1450 with other devices. The external interface 1462 can provide, for example, for wired communication in some implementations, or for wireless communication in other implementations, and multiple interfaces can also be used.

The memory 1464 stores information within the mobile computing device 1450. The memory 1464 can be implemented as one or more of a computer-readable medium or media, a volatile memory unit or units, or a non-volatile memory unit or units. An expansion memory 1474 can also be provided and connected to the mobile computing device 1450 through an expansion interface 1472, which can include, for example, a SIMM (Single In Line Memory Module) card interface. The expansion memory 1474 can provide extra storage space for the mobile computing device 1450, or can also store applications or other information for the mobile computing device 1450. Specifically, the expansion memory 1474 can include instructions to carry out or supplement the processes described above, and can include secure information also. Thus, for example, the expansion memory 1474 can be provide as a security module for the mobile computing device 1450, and can be programmed with instructions that permit secure use of the mobile computing device 1450. In addition, secure applications can be provided via the SIMM cards, along with additional information, such as placing identifying information on the SIMM card in a non-hackable manner.

The memory can include, for example, flash memory and/or NVRAM memory (non-volatile random access memory), as discussed below. In some implementations, a computer program product is tangibly embodied in an information carrier. The computer program product contains instructions that, when executed, perform one or more methods, such as those described above. The computer program product can be a computer- or machine-readable medium, such as the memory 1464, the expansion memory 1474, or memory on the processor 1452. In some implementations, the computer program product can be received in a propagated signal, for example, over the transceiver 1468 or the external interface 1462.

The mobile computing device 1450 can communicate wirelessly through the communication interface 1466, which can include digital signal processing circuitry where necessary. The communication interface 1466 can provide for communications under various modes or protocols, such as GSM voice calls (Global System for Mobile communications), SMS (Short Message Service), EMS (Enhanced Messaging Service), or MMS messaging (Multimedia Messaging Service), CDMA (code division multiple access), TDMA (time division multiple access), PDC (Personal Digital Cellular), WCDMA (Wideband Code Division Multiple Access), CDMA2000, or GPRS (General Packet Radio Service), among others. Such communication can occur, for example, through the transceiver 1468 using a radio-frequency. In addition, short-range communication can occur, such as using a Bluetooth, WiFi, or other such transceiver (not shown). In addition, a GPS (Global Positioning System) receiver module 1470 can provide additional navigation- and location-related wireless data to the mobile computing device 1450, which can be used as appropriate by applications running on the mobile computing device 1450.

The mobile computing device 1450 can also communicate audibly using an audio codec 1460, which can receive spoken information from a user and convert it to usable digital information. The audio codec 1460 can likewise generate audible sound for a user, such as through a speaker, e.g., in a handset of the mobile computing device 1450. Such sound can include sound from voice telephone calls, can include recorded sound (e.g., voice messages, music files, etc.) and can also include sound generated by applications operating on the mobile computing device 1450.

The mobile computing device 1450 can be implemented in a number of different forms, as shown in the figure. For example, it can be implemented as a cellular telephone 1480. It can also be implemented as part of a smart-phone 1482, personal digital assistant, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms machine-readable medium and computer-readable medium refer to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term machine-readable signal refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (LAN), a wide area network (WAN), and the Internet.

The computing system can include clients and servers. A client and server are generally remote from each other and typically interact through a communication network. The relationship of client and server arises by virtue of computer programs running on the respective computers and having a client-server relationship to each other.

What is claimed is:

1. A system for the management of data, the system comprising:
one or more processors; and
computer-readable memory storing instructions that, when executed by the processors, cause the processors to perform operations comprising:
receiving, for each of a plurality of orders, an inventory readiness date that specifies a first calendar date on which the order of items should be ready at each items' respective destination location;
determining, for each item of each order, an arrival date before the readiness date, the arrival date specifying a second calendar date on which the item should arrive at the item's respective destination location;
maintaining, for each item of the order, a corresponding load that the item is a member of;
generating, for each item of the plurality of orders, an inventory readiness metric based on the item's travel based on tracking data for the item's load as the item's load travels from the item's respective source location to the respective destination location;
receiving a query that requests a load metric of a particular load to reflect the inventory readiness metrics of the items of the particular load; and
returning, in response to the query, a load metric generated from an aggregation of the inventory readiness metrics of the items of the load.

2. The system of claim 1, the operations further comprising:
generating a graphic user interface (GUI) having interaction elements to generate the query for the load metric; and
displaying, in the GUI, the load metric.

3. The system of claim 2, wherein:
the query further requests location information for the load; and
displaying, in the GUI, the load metric further comprises showing the location information for the load in a graphical image.

4. The system of claim 2, wherein:
the query further requests load metrics of a group of load matching a particular parameter; and
displaying, in the GUI, the load metric further comprises displaying load metrics for each load matching the particular parameter.

5. The system of claim 1, wherein the operations further comprise:
receiving tacking data for a particular load;
determining, based on the receive tracking data, that at least one inventory readiness metric should be updated based on the updated tracking data; and
updating one or more readiness metrics of items of the load based on the received tracking data.

6. The system of claim 5, wherein determining, based on the receive tracking data, that at least one inventory readiness metric should be updated based on the updated tracking data comprises:
comparing the received tracking data to stored progress estimations for the load;
determining that the load is failing to meet the progress estimations for the load based on the received tracking data.

7. The system of claim 6, wherein the progress estimations are generated based on carrier-provided estimates of progress for the load.

8. The system of claim 7, wherein the progress estimates are further generated based on historic accuracy scores for the carrier that record an accuracy measure of historic carrier-provided estimates from the same carrier for historic loads.

9. The system of claim 1, wherein a difference between the first calendar date and the second calendar date is determined based on capabilities of the destination location for the item.

10. A method for the management of data, the method comprising:
receiving, for each of a plurality of orders, an inventory readiness date that specifies a first calendar date on which the order of items should be ready at each items' respective destination location;
determining, for each item of each order, an arrival date before the readiness date, the arrival date specifying a second calendar date on which the item should arrive at the item's respective destination location;
maintaining, for each item of the order, a corresponding load that the item is a member of;
generating, for each item of the plurality of orders, an inventory readiness metric based on the item's travel based on tracking data for the item's load as the item's load travels from the item's respective source location to the respective destination location;
receiving a query that requests a load metric of a particular load to reflect the inventory readiness metrics of the items of the particular load; and
returning, in response to the query, a load metric generated from an aggregation of the inventory readiness metrics of the items of the load.

11. A method for the management of data includes:
receiving, for each of a plurality of orders, an inventory readiness date that specifies a first calendar date on which the order of items should be ready at each items' respective destination location;
determining, for each item of each order, an arrival date before the readiness date, the arrival date specifying a second calendar date on which the item should arrive at the item's respective destination location;
maintaining, for each item of the order, a corresponding load that the item is a member of;
generating, for each item of the plurality of orders, an inventory readiness metric based on the item's travel based on tracking data for the item's load as the item's load travels from the item's respective source location to the respective destination location;
receiving a query that requests a load metric of a particular load to reflect the inventory readiness metrics of the items of the particular load; and
returning, in response to the query, a load metric generated from an aggregation of the inventory readiness metrics of the items of the load.

12. The method of claim 11, the method further comprising:
generating a graphic user interface (GUI) having interaction elements to generate the query for the load metric; and
displaying, in the GUI, the load metric.

13. The method of claim 12, wherein:
the query further requests location information for the load; and
displaying, in the GUI, the load metric further comprises showing the location information for the load in a graphical image.

14. The method of claim 12, wherein:
the query further requests load metrics of a group of load matching a particular parameter; and
displaying, in the GUI, the load metric further comprises displaying load metrics for each load matching the particular parameter.

15. The method of claim 11, wherein the method further comprises:
receiving tacking data for a particular load;
determining, based on the receive tracking data, that at least one inventory readiness metric should be updated based on the updated tracking data; and
updating one or more readiness metrics of items of the load based on the received tracking data.

16. The method of claim 15, wherein determining, based on the receive tracking data, that at least one inventory readiness metric should be updated based on the updated tracking data comprises:
comparing the received tracking data to stored progress estimations for the load;
determining that the load is failing to meet the progress estimations for the load based on the received tracking data.

17. The method of claim 16, wherein the progress estimations are generated based on carrier-provided estimates of progress for the load.

18. The method of claim 17, wherein the progress estimates are further generated based on historic accuracy scores for the carrier that record an accuracy measure of historic carrier-provided estimates from the same carrier for historic loads.

19. The method of claim 11, wherein a difference between the first calendar date and the second calendar date is determined based on capabilities of the destination location for the item.
